(19) United States
(12) Patent Application Publication
(10) Pub. No.: US 2004/0166817 A1
(43) Pub. Date: Aug. 26, 2004

(54) System, method and apparatus for burst communications

(76) Inventors: Mehran Mokhtari, Thousand Oaks, CA (US); Hossein Izadpanah, Newbury Park, CA (US)

Correspondence Address: Ross A. Schmitt, ESQ., c/o LADAS & PARRY, Suite 2100, 5670 Wilshire Boulevard, Los Angeles, CA, 90036-5679, US

(21) Appl. No.: 10/761,923

(22) Filed: Jan. 20, 2004

Related U.S. Application Data
(60) Provisional application No. 60/441,514, filed on Jan. 20, 2003.

(51) Int. Cl. H04B 1/38

(52) U.S. Cl. 455/91; 455/73

(57) ABSTRACT

A communication system for digital communications comprising a transmitter which transmits digital data bits by direct on-off keying of a carrier to producing a burst and a receiver which receives the burst and recovers the digital data transmitted by the burst.

### CROSS-REFERENCE TO RELATED APPLICATIONS

The present application is related to and claims the benefit of U.S. Provisional Patent Application No. 60/441,514, filed Jan. 20, 2003 and titled “Synchronized Digital Radio Frequency Burst Communication Systems.” The contents of U.S. Provisional Patent Application No. 60/441,514 are incorporated by reference herein in their entirety.

### BACKGROUND

1. Field

This disclosure relates generally to communication systems and more particularly a method and apparatus for digital data communication. Specifically, a method and apparatus for a digital burst communication system (DBCS) are described herein.

2. Description of Related Art

Communication of digital data is well known in the industry. Modulation techniques such as Quadrature Phase Shift Keying (QPSK), Quadrature Amplitude Modulation (QAM) are used to transmit voice and data in a digital format in applications from cell-phones to direct-to-home satellite transmission using wireless techniques. However, communication systems using these digital modulation techniques (and others known in the art) typically use transmitters and receivers that rely upon well-known heterodyne techniques for modulating and demodulating a carrier-based “analog” transmission and reception of the digital data, which is typically processed by digital-to-analog converters before modulation and analog-to-digital converters after de-modulation.

Many different approaches have been adopted for wireless communication of digital data at radio frequencies. Homodyne, (super) heterodyne, IF/sub-sampling, Ultra Wide Band (UWB), are just a few of the many well-known approaches. All of these well-known approaches (except UWB) may be generalized as analog approaches for the transmission of digital data, since the digital data is, at some point, converted to the analog domain before transmission and converted back from the analog data after reception.

Communication of data using optics and/or optical devices is also known in the art. In optical fiber (i.e., guided wave) communication systems, the transmission is typically either based on using a modulated lower frequency carrier that then modulates an optical carrier (e.g., RF in Fiber) or direct digital transmission techniques without the additional lower frequency carrier where the data is transmitted using Return-to-Zero (RZ) or Non-Return-to-Zero (NRZ) bit-representation.

FIG. 1A depicts the simplified functional blocks and architecture of a typical heterodyne radio frequency (RF) communication system having a transmitter 120 and a receiver 140 for the transmission and reception of digital data modulated on a carrier. The transmitter 120, apart from various filters (BP) 129, comprises one or more Digital-to-Analog Converters (DAC) 110, one or more phase shifters 121, one or more intermediate frequency (IF) generators 122, one or more up-converting IF, mixers 124, a RF carrier generator 130, an up-converting RF mixer 126, one or more Variable Gain Amplifiers 127, a Power Amplifier 128 and a transmitting antenna 132. The digital data is converted to an analog signal by means of the one or more DACs 110 to create an analog base-band signal. The IF-generator 122 provides a low frequency signal to the IF mixer 124. The IF mixer 124 modulates the base-band signal onto the IF creating a modulated signal. The RF up-converter 126 or mixer receives the IF modulated signal and an RF carrier signal from the RF carrier generator 130 to produce an RF modulated signal. The RF signal is then amplified with the variable gain amplifier 127 and power amplifier 128 and radiated from the antenna 132. In order to improve the communication quality, many systems utilize orthogonal carriers (I and Q channels). Such systems commonly use phase shifters 121 and combiners 125 as shown in FIG. 1A. Those skilled in the art will understand that other RF transmitters known in the art for digital data transmission may comprise different components than those shown in FIG. 1A.

The receiver 140 shown in FIG. 1A, apart from various filters (BP), comprises a receiving antenna 152, a Low Noise Amplifier (LNA) 148, a RF down converter 146, an RF generator (normally as part of a Phase Locked Loop, not shown in the figure) 150, intermediate frequency generator 145, one or more IF demodulators 144 and one or more Analog-to-Digital (ADC) converters 141. The RF signal from the transmitter 120 is received by the antenna 152 and is amplified by the LNA 148. The down converter 146 mixes the received RF modulated signal with the RF local oscillator signal 150 to produce the IF modulated signal. The IF modulated signal is then coupled to the IF demodulator 144 where the received base-band data 114 is extracted. In systems utilizing orthogonal carriers, one or more phase shifter functions 142 will be necessary to separate the I and Q channels. The ADCs convert the base-band signal to digital data. Again, those skilled in the art will understand that other RF receivers known in the art for digital data reception may comprise different components than those shown in FIG. 1A.

FIG. 1B shows the simplified functional blocks and architecture for a prior art communication system using optical fiber. In the system depicted in FIG. 1B, the transmitter comprises a time-multiplexing unit 2010 that converts parallel data into a high-speed serial bit-stream. The serial bit-stream is then coupled into a wide-band laser or laser-modulator driver 2020. The modulated light output by the driver 2020 is coupled into optical fiber 2030, which transports the modulated light to a receiver. At the receiver, the modulated light is detected by a photo-detector and amplifier combination 2040. The amplifier typically comprises a front-end wideband low noise amplifier and may be followed by a limiting amplifier chain. The detected signal is coupled to a clock recovery unit 2060 for receiver synchronization and to a decision circuit 2050 for re-timing purposes. Finally, the bit-stream is de-multiplexed by a demultiplexer 2070 to parallel formatted data for further processing.

The communication systems shown in FIGS. 1A and 1B, although well known in the art, comprise components that require relatively complex transmitter and receiver circuits. Furthermore, these components, which are essentially analog high frequency components, add to both the size and power consumption of the transmitter and receiver of the communication system. Further, linear performance of the components is often of utmost importance, since non-linearities may corrupt the data or degrade the performance of the communication. Obtaining linear performance for a particular component may require added circuits, resulting in increased complexity of the transmitter and/or receiver circuits. The complexity, size, and power consumption of the communication systems shown in FIGS. 1A and 1B tend to increase the cost of the systems and decrease their reliability, especially when the data transmission rate is increased. Hence, there is a need in the art for less complex systems for transmitting and receiving digital data.

Further examples of other systems known in the art for communicating digital data are shown in FIGS. 2, 3, and 4. As briefly noted above, a common feature of the prior art digital communication systems depicted in FIGS. 1A, 2, 3, and 4 is that the systems actually transmit and receive “analog” signals. That is, one or more DACs are needed in the transmitter to convert the digital data to an analog format before modulation and one or more ADCs are required in the receiver to convert the analog signal received from the demodulator to digital data.

The conventional “carrier” based analog RF wireless communication technology as depicted in the example communication systems shown in FIGS. 1A, 2, 3, and 4 suffers from many technical/operational issues and performance limitations. The technology typically requires many power consuming, low efficiency, and highly linear devices and circuits. In addition, complex electronic design and implementation techniques are needed to mitigate and compensate these effects in order to maintain the signal integrity and fidelity. Examples include: low noise/high IP3 up/down mixers; high resolution/high sample-rate analog-to-digital and digital-to-analog converters; multiple IF stages; high-Q, bulky “off-chip” filters and switches; highly linear power and low noise amplifiers; and complex nonlinearity effects compensating/equalizing circuits.

An additional limitation of conventional digital data communication systems is the data rate at which such systems can operate. With the provision of optical fiber-based networks and increasing numbers of computers generating and transmitting ever increasing amounts of data, there is an ever increasing desire to transmit this data using wireless systems, due to the mobility and dynamics that such systems provide. Wireless digital data communication systems are essentially limited to RF-based systems and optically-based systems.

RF-based systems offer an advantage of low sensitivity to atmospheric degradation. However, due to current modulation schemes, and the necessary high carrier power to data power ratio to achieve an “open eye” and acceptable Bit Error Rate (BER), RF-based systems encounter physical limits on the transmission rate of digital data. Higher carrier frequencies allow higher data rates, but the atmospheric attenuation is also increases with frequency (up to quasi-optical frequencies).

UWB systems (briefly mentioned above) are generally considered to be fully digital with data pulse format. Hence, UWB systems may provide advantages over the conventional digital data communication systems described above. However, as indicated by their acronym, ultra wideband systems generally require a significantly larger bandwidth for the transmission of data than the conventional systems described above. This bandwidth requirement may limit the data transmission rate of a UWB system or limit the types of components that may be used in the UWB system.

Free space optically-based systems, which use carrier frequencies at terahertz (THz), offer higher data transmission rates, may suffer from atmospheric attenuation and scintillation and are typically strongly dependent on atmospheric conditions. Optical systems typically also suffer from the same power and complexity problems seen with conventional high frequency radio frequency systems.

Guided-wave communication systems (e.g., optical fiber communication systems) typically suffer from the fact that the components used in such systems must generally be wideband (preferably DC-coupled) components. The wideband components have noise constraints and may also provide minimum bandwidth, such that guided-wave systems suffer from performance problems, especially in ultra long haul applications.

As such, both conventional RF-based systems for high data rate transmission and optically-based systems may be gradually limited in range and data rate.

Therefore, there exists a need in the art for digital communication systems that provide for transmitters and receivers with decreased complexity, decreased weight and power consumption, and increased efficiency while still providing capabilities for high data rate communication.

### SUMMARY

Embodiments of the present invention provide a method and apparatus for communicating digital data in the digital domain. These embodiments may provide for transmission and reception of digital data without the use of digital-to-analog and analog-to-digital conversion circuits as are used in prior art digital wireless communication systems and without the necessity of ultra wideband front-end electronics in DC-coupled guided-wave systems (e.g., fiber optic communications systems). These embodiments also provide for transmission and reception of digital data without signal up conversion and down conversion techniques well-known in the art. Embodiments of the present invention also allow for the use of a remotely generated RF, microwave, millimeter wave, or optical carrier signal.

Preferred embodiments of the present invention provide an all-digital wireless communication system where the digital data bits are carried by bursts of a single frequency RF or optical carrier. A transmitter according to some embodiments of the present invention radio frequency burst gates the carrier by the digital data bits by using high-speed digital integrated circuits. In some embodiments of the present invention, a receiver uses all-digital circuits to directly count/integrate the RF or optical burst cycles and events via synchronous detection to determine the transmitted digital bits.

Preferred embodiments according to the present invention provide an end-to-end all-digital ultra-high speed transmission system where no analog-to-digital or digital-to-analog conversion is required and where no up- or down-data conversion is required. While embodiments according to the present invention may use low noise amplifiers and/or power amplifier, the linearity constraints on Low Noise Amplifier and Power Amplifier are considerably more relaxed than the typical current solutions. Furthermore, the complex nonlinear power consuming electronics circuits and processing (such as mixers, analog-to-digital conversion and digital-to-analog conversion circuits, intermediate frequency (IF) circuits, high quality frequency selective filters, etc.) typically used in prior art systems may be eliminated, resulting in simple, compact, low power, low cost, high reliability radio, optic and/or fiber optic transmission systems.

Embodiments of the present invention, in the case of wireless systems, may minimize the impact of signal degradation due to propagation impairments, reflection, multi-path and interference due to the preferred “frequency/event counting/integrating” method of detection. Resulting systems may provide for very high-speed data transmission, for example, greater than >10 Gbps at 30-90+ GHz with technologies known in the art. Fiber optical transmission systems according to the present invention should demonstrate improved receiver sensitivity and improved driver efficiency, due to the introduced narrow band characteristics. Hence, embodiments of the present invention provide high data rate (up to the carrier frequency used to transmit the RF bursts) robust RF and/or optical wireless links and/or optical fiber links and communication networks for a variety of high speed communication applications.

### BRIEF DESCRIPTION OF THE DRAWINGS

The features and advantages of the present invention will become better understood with regard to the following description, appended claims, and accompanying drawings.

FIG. 1A (prior art) shows a generalized embodiment of a communication system for the wireless transmission of digital data.

FIG. 1B (prior art) shows a generalized embodiment of a communication system for optical fiber transmission of digital data.

FIG. 2 (prior art) shows a functional block diagram of a communication system for the wireless transmission of digital data using a double conversion receiver.

FIG. 3 (prior art) shows a block diagram of a communication system for the wireless transmission of digital data using a direct conversion receiver.

FIG. 4 (prior art) shows a block diagram of a communication system for the wireless transmission of digital data using a direct IF sampling receiver.

FIG. 5 shows a generalized embodiment of a digital burst communication system according to an embodiment of the present invention.

FIG. 6 depicts an RF generator according to an embodiment of the present invention.

FIG. 7 shows a block diagram of an RF receiver according to an embodiment of the present invention.

FIG. 8 shows a block diagram of an alternative embodiment of a digital burst transmitter according to the present invention.

FIG. 9 shows a block diagram of another embodiment of a digital transmitter according to the present invention.

FIG. 10 shows a block diagram of another embodiment of a digital receiver according to the present invention.

FIG. 11 shows a block diagram of another embodiment of a digital receiver according to of the present invention.

FIG. 12 shows a block diagram of a digital transmitter according to the present invention used for simulation studies.

FIG. 13 shows a block diagram of a digital receiver according to the present invention used for simulation studies.

FIG. 14 shows transmission simulation results.

FIG. 15 shows the transmitter input and receiver output direct and multi-path resulting eye-diagrams at the receiver end obtained from the simulation study.

FIG. 16 shows examples of opto-electronic RF bursts generated at different data rates and different frequency bands.

FIG. 17 illustrates a communication system according to another embodiment of the present invention in which the RF burst signal is transmitted by a vertically polarized antenna and a horizontally polarized antenna.

FIG. 18 shows a block diagram of an optical digital burst communication system according to an embodiment of the present invention.

FIG. 19 shows a block diagram of an optical digital burst communication system according to an embodiment of the present invention using a RF burst transmitter and a RF burst receiver.

FIG. 20 shows a block diagram of an optical digital burst communication system according to an embodiment of the present invention using an optical ON/OFF modulator and a RF burst receiver.

FIG. 21 shows a band tunable digital burst communication system according to an embodiment of the present invention.

FIG. 22 shows an digital burst communication system envelope receiver according to an embodiment of the present invention.

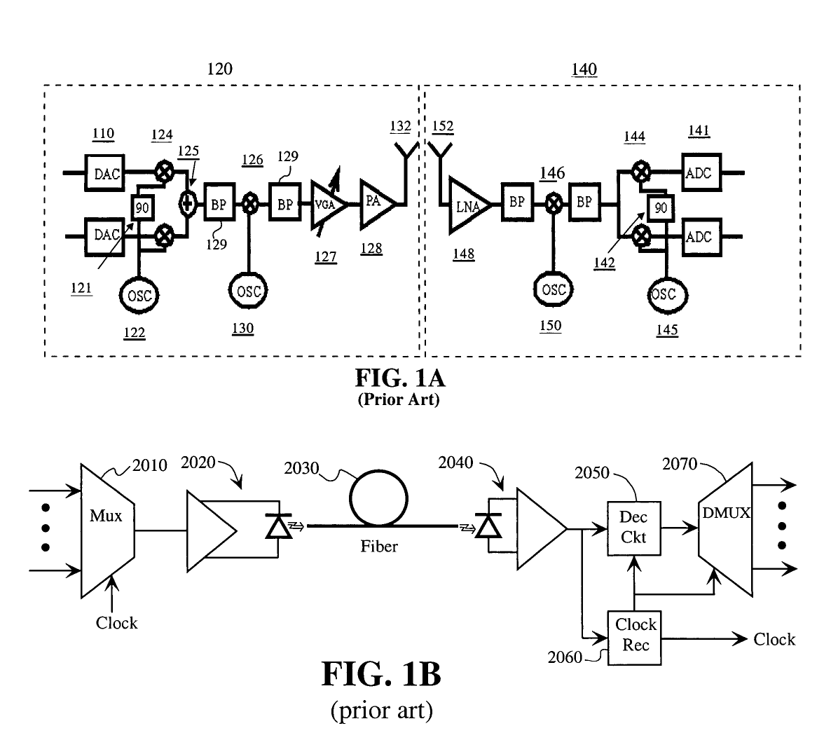

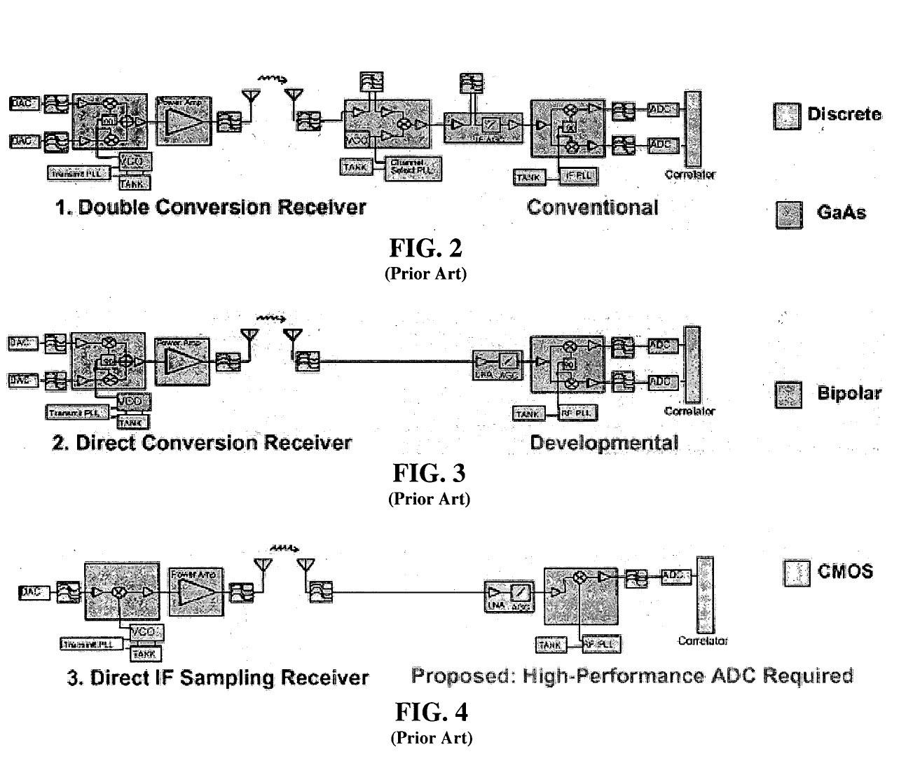

### DETAILED DESCRIPTION

The present invention will now be described more fully hereinafter with reference to the accompanying drawings, in which preferred embodiments of the invention are shown. This invention may be embodied in many different forms and should not be construed as limited to the embodiments set forth herein. Further, the dimensions of certain elements shown in the accompanying drawings may be exaggerated to more clearly show details. The present invention should not be construed as being limited to the dimensional relations shown in the drawings, not should the individual elements shown in the drawings be construed to be limited to the dimensions shown.

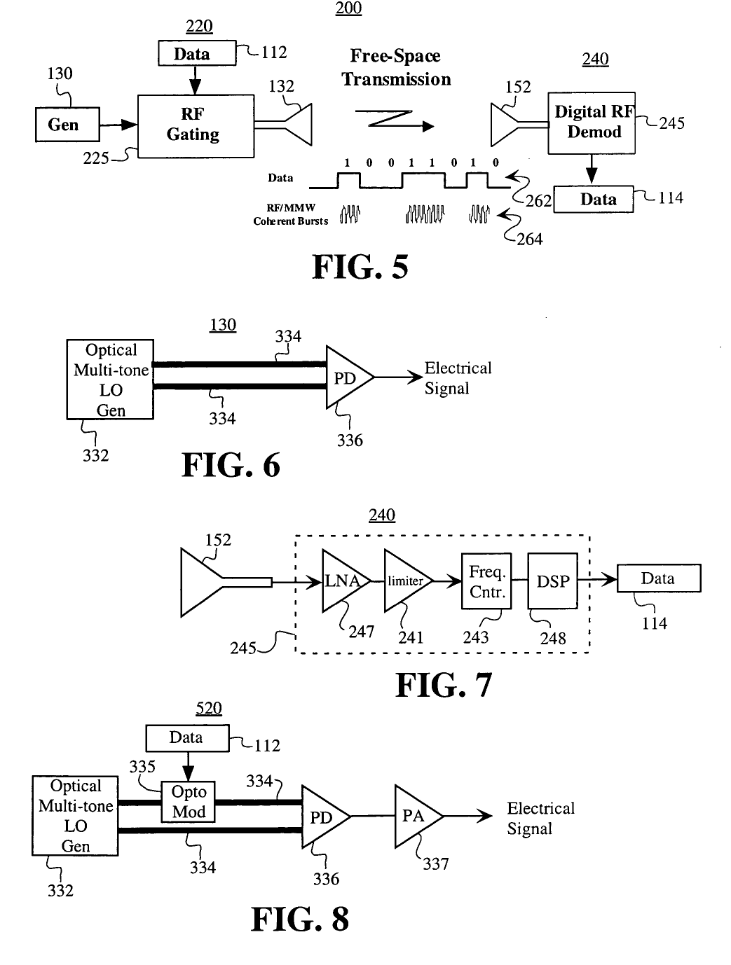

FIG. 5 shows a block diagram for a one-way communication channel 200 according to an embodiment of the present invention. Those skilled in the art will understand that two way communications may be provided by replicating the channel 200 in the opposite direction. In FIG. 5, a digital transmitter 220 comprises a single frequency RF generator 130, a digital gating device 225, and a transmitting antenna 132. The RF generator 130 may generate a radio frequency (RF) output, a microwave (MW) output and/or a millimeter wave (MMW) output. The digital gating device 225 chops the RF/MW/MMW continuous carrier from the RF generator 130 into digital bursts 264 based on the state of the digital input data 112. Preferably, as shown in FIG. 5, an RF/MW/MMW carrier signal 264 is present when the bit state 262 of the digital data is a “1” and there is no carrier signal 264 when the bit state 262 is a “0”. According to an embodiment of the present invention, a digital receiver 240 comprises a receiving antenna 152 and digital RF data recovery circuitry 245.

The RF generator 130 may comprise any one of multiple circuits or devices well-known in the art for generating electrical carrier waves. The frequency of the carrier wave may vary from frequencies as low as those used for standard amplitude modulation radio broadcasts or even lower to very high frequencies into the millimeter wave and recently opened sub-millimeter wave frequency band (71-140 GHz). For example, a magnetron, Klystron, integrated oscillators and/or a high power transistor oscillator may be used to generate a RF carrier wave at microwave frequencies (1-10 GHz). For higher frequencies, integrated semiconductor oscillator circuits known in the art may be used to generate an RF carrier wave at radio frequencies of 1-100 GHz. Such circuits or devices may be located very close to the digital gating device 225 or, in the case of integrated semiconductor circuits, may be integrated with the digital gating device 225 to avoid the loss and distortion that may arise if the carrier wave is conducted over relatively long transmission lines to the digital gating device 225, especially at higher frequencies.

FIG. 6 depicts an embodiment of an opto-electronic RF generator 130 for use with embodiments of the present invention. The RF generator 130 in FIG. 6 uses a centrally generated multiple tone local oscillator optical signal. Generation of a multiple tone optical signal that can be converted into an RF carrier is known in the art. Optical heterodyning is used to create a sum or difference beat frequency between two continuous wave optical wavelength tones. To generate an appropriate local oscillator signal for use with embodiments of the present invention, the two continuous wave optical signals may be directed at a photo diode, which then provides an RF carrier wave dependent on the sum or difference beat frequency. Hence, the RF generator 130 comprises a multiple tone optical signal generator 332, optical transporting fiber 334, and a photo-detector 336.

The multiple tone optical signal generator 332 may be located remotely from the rest of the digital transmitter 220. The optical signal generator 332 may be located in a remotely located Network Operations Center (NOC) in which frequency tuneability and multiple-band switching in the optical domain is provided. Given the optical heterodyning techniques described above, the NOC can also provide the capability to remotely control the frequency at which the digital transmitter 220 operates. That is, the frequency of one or both of the multiple optical tones may be adjusted to provide the desired RF carrier wave output at the digital transmitter 220. Further, since the optical fiber 334 preferably has very low loss and distortion characteristics, one skilled in the art will appreciate the fact that the NOC may be located a significant distance from the rest of the digital transmitter 220. The NOC may also provide additional control and management over the digital transmitter 220 via digital commands embedded in the optical signals sent to the digital transmitter.

The photo-detector 336 used to convert the optical signal from the optical fiber 334 into an RF/MW/MMW carrier signal may comprise a PIN diode or a uni-traveling-carrier photodiode (UTC-PD). Such diodes are known to have high-speed and high power characteristics. High output power sufficient to drive a digital gate or an antenna element has been demonstrated from UTC-PDs up to 13 dBm at 65 GHz.

FIG. 16 shows examples of opto-electronic RF bursts generated at different data rates and different frequency bands. The dotted window around the carrier indicates the required bandwidth for antenna and receiver electronics. These examples show the carrier wave well above (at least 20 dB) the floor of the spectrum.

Optically-based solutions for generating the requisite RF carrier wave may be particularly useful for base station applications, that is, where a single transmitter 220 may be communicating with multiple receivers. Optically generated RF carrier waves have desirable stability and low noise characteristics, but the optical generation of the RF carrier wave may increase the size, complexity and power requirements of the system. Therefore, where lower power, size, or complexity is desired, such as in compact portable systems, tuneability of the RF carrier wave generator 130 may also be accomplished using wide tuning range Voltage Controlled Oscillators (VCO) and/or VCO banks known in the art. Such devices may be utilized to make available a range of frequencies, using fully electronic means, for more compact solutions.

Returning to FIG. 5, the digital gating device 225 preferably comprises simple digital circuitry for gating the RF carrier on or off. For example, the digital modulator 225 may simply comprise a high-speed AND gate. High-speed digital gates known in the art have output levels to drive an antenna element to provide sufficient radiated power at millimeter wave frequencies without the use of a power amplifier at the output of the gate. Hence, some embodiments of the present invention do not require additional amplification after the digital modulator 225. However, a power amplification stage may be used to drive the antenna 132 for higher transmit power and provide impedance matching between the digital gating device 225 and the antenna 132.

Another embodiment of a digital transmitter 520 according to the present invention is shown in FIG. 8. This digital transmitter 520 relies directly upon the optical heterodyning technique described above to provide a modulated RF carrier wave without using a separate digital gating device that operates in the RF domain. In the digital transmitter shown in FIG. 6, the multiple tone optical signal generator 332 is still used to generate at least two continuous optical wave signals. FIG. 8 shows these optical signals being output on two separate optical fibers 334, but a single fiber may be used to carry the multiple optical carriers. One of the optical carrier wave signals is coupled to an optical modulator 335 controlled by the data signal 112. In a preferred mode of operation, the data signal 112 merely switches the optical carrier wave signal on and off at the optical modulator 335. The two optical carrier wave signals are then directed to the photo detector 336 in which optical heterodyning occurs. As described above, when both optical carrier wave signals are present at the photo detector 336, an RF carrier wave signal will be presented. However, when one of the optical carriers is switched off by the optical modulator 335, there will be no RF carrier signal output, since there will be no beat frequency present. As described above, the presence or absence of the RF carrier indicates the transmission of a “1” or “0” digital data bit. To provide a higher power output, a power amplifier 337 may be coupled to the output of the photo-detector.

The frequency of the carrier wave generated from the RF generator 130, whether locally or remotely located, may be tuned and selected so as to minimize atmospheric propagation attenuation or other attenuating or distorting conditions. For example, in clear air, transmission of a signal with a carrier frequency of 71 GHz has a lower attenuation than transmission at 60 GHz. However, if rain is present, transmission at 60 GHz has a lower attenuation that transmission at 71 GHz. Since preferred embodiments of the present invention comprise digital components that have a large bandwidth (e.g. DC to 100 GHz), the same circuits and components can handle such a wide change of operating frequency without requiring specific reconfiguration to the selected frequency. If the frequency of the RF generator is optically generated and controlled from a NOC, additional functions within the NOC may be used to determine the atmospheric conditions in which the communication system 200 is operating.

The transmitting antenna 132, in wireless applications, may comprise a low profile, high gain planar, integrated, and conformal antenna configured for operation at the selected frequency bands. As noted above, embodiments of the present invention are particularly suited for operation at higher frequencies (e.g. millimeter wave frequencies). Another major advantage of operation of embodiments of the present invention at millimeter wave frequencies is that millimeter wave antennas generally have a small footprint for narrow pencil type beams, which can be used for point-to-point links with minimal interference with the adjacent links. Hence, the narrow beams allow multiple users to co-exist in relatively close geographical vicinities without any cross channel interference.

The digital receiver 240 shown in FIG. 5 may be implemented in a first embodiment as shown in more detail in FIG. 7. FIG. 7 shows the digital receiver 240 comprising a low noise amplifier (LNA) 247, a limiter circuit 241, a frequency counter 243 and digital signal processor circuitry 248. The embodiment of the digital receiver 240 depicted in FIG. 7 operates by counting the cycles in each received RF burst signal. As described above, a digital bit is established by the presence or absence of the RF carrier wave, i.e. the RF burst. Each digital bit may be further established by a specific number of cycles of the RF carrier wave within the RF burst. Hence, by counting the cycles and event recording (the presence or the absence of RF carrier), a digital bit can be established.

In the digital receiver 240 depicted in FIG. 7, the LNA 247 is used to boost the received signal, but the LNA 247 may be operated well into its saturation for highest power efficiency, unlike conventional wireless receivers. The nonlinear effects seen when the LNA 247 is operated at saturation are not a concern, since these nonlinear effects generally do not affect the burst demodulated cycles of the received signal. In fact, the nonlinear effects are useful in “squaring up” the received cycles for better efficiency, as described below. Hence, embodiments of the present invention allow for the use of relatively low power, but highly efficient low noise amplifiers when is operated well into the saturation mode.

In the digital receiver 240, the amplified signal output by the LNA 247 is preferably coupled to a limiter circuit 241. The limiter circuit 241 serves limit the amplitude of the received burst signal and, in so doing, tends to “square-up” each cycle of the received burst signal. That is, the limiter circuit 241 tends to clip each cycle of the carrier wave within the received RF burst, so that the remaining carrier wave has faster transitions for each cycle. The clipping or squaring of each cycle of the RF burst helps facilitate the frequency counting, as described below.

As indicated above, the frequency counter 243 simply counts the number of cycles within an RF burst. However, in embodiments of the present invention, this frequency or cycle counting capability may be provided by all digital circuitry. The frequency counter 241 detects each cycle of the carrier wave in the RF burst, counts the number of cycles from the beginning of a bit period, and then provides a “0” or “1” output depending on the number of the number of cycles detected as absent or present. Synchronous detection is preferably used to perform the counting, so a simple Phased Lock Loop (PLL) and/or an injection locked Voltage Controlled Oscillator (IL-VCO) may be used to generate the sync signal for the counter circuitry. Both PLLs and IL-VCOs are well-known in the art.

The final block in the digital receiver shown in FIG. 7 is DSP circuitry 248. The DSP circuitry 248 may be used to decode the received data, remove any framing applied to the data, or perform any additional processing on the data to fully recover the transmitted data 112 as received data 114. As described in additional detail below, the DSP circuitry 248 may also be used to generate receiver control information from the received RF burst data for control and configuration of the digital receiver 240.

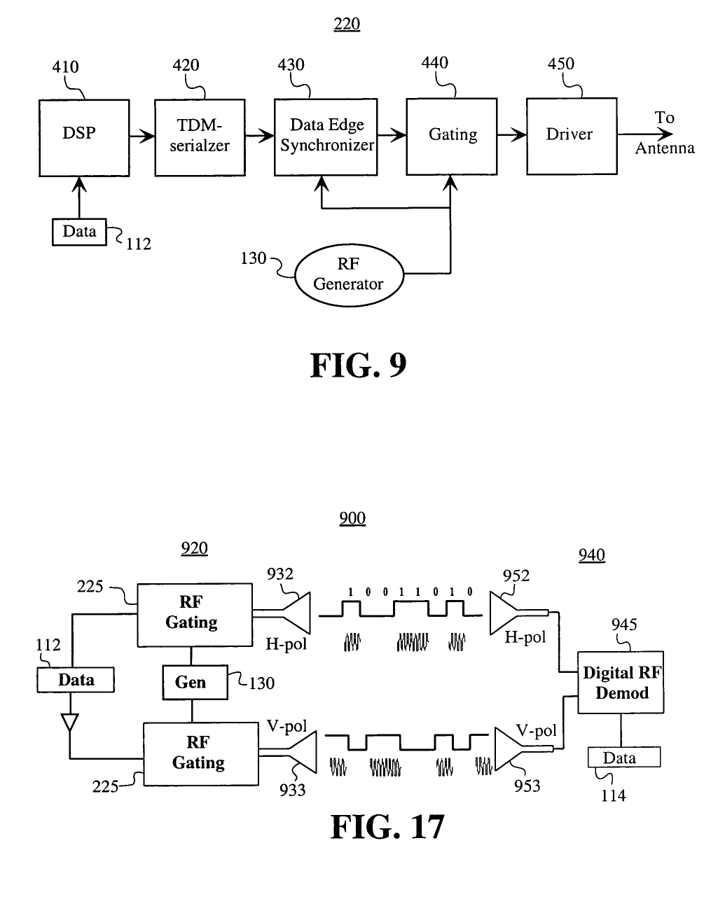

FIG. 9 shows a block diagram for another embodiment of the digital transmitter 220 according to the present invention. As shown in FIG. 9, a digital signal processor (DSP) 410 receives the data 112 which may be in either a parallel or serial form. The DSP handles preprocessing of the digital data 112, for example coding, encryption and/or framing. The DSP processed data is then provided to a time division multiplexer (TDM) serializer 420 to provide a serial data stream. The serial data stream is then synchronized with a radio frequency carrier signal from the RF generator 130 by a data edge synchronizer 430. Gating circuitry 440 is controlled by the synchronized signal to gate the RF carrier signal. The gating may simply be on and off gating that can be provided by a high speed AND gate. If the gating circuitry 440 provides sufficient drive, the gating circuitry may be directly connected to a transmitting antenna 132 (not shown in FIG. 9). In another embodiment, the gating circuitry 440 is connected to an antenna driver circuit 450.

The DSP 410 may perform preprocessing on the digital data 112 to better condition the data for the all-digital transmission capability provided by the digital transmitter 220. The preprocessing may include scrambling and encrypting the data for more secure transmission. The DSP preprocessing may also include the introduction of error correcting codes and/or operations for improved Bit Error Rate (BER) performance. The DSP preprocessing may further include data frame generation, data header creation, and other data organization techniques. The DSP 410 may comprise one or more general purpose microprocessors known in the art. However, when high speed and/or low power consumption are desired, the use of application specific DSPs is preferred.

Since the output of the DSP may be a parallel data stream, the TDM serializer 420 is simply used to convert the parallel data stream to a serial stream. This serialization function may be incorporated into the DSP 410.

The data edge synchronizer 430 in its simplest form is just a re-timing circuit (e.g., a flip-flop). However, it is preferred that the RF burst signal be synchronized to begin at a specific part of a cycle of the carrier wave within the burst. If this synchronization is not performed, the demodulation of the RF burst at the digital receiver may be 240 may be complicated or the maximum data rate allowed by the system may be limited. Circuits that provide that gated carrier wave start at a specified portion of a cycle within the carrier wave are known in the art. For example, the data edge synchronizer 430 may comprise a wide-band limiting amplifier or amplifier chain, followed by a Latch or a D-type flip-flop. As shown in FIG. 9, the same local oscillator signal that is provided to the gating circuitry 440 is also used to clock the flip-flop. The limiting amplifier helps to enhance the bandwidth of the digital stream by providing sharper transitions between the binary states of the digital signal. These sharper transitions in the digital signal help ensure that the gated RF burst begins at a particular part of a cycle within the carrier.

As indicated above, the gating circuitry 440 may be a simple “AND” gate that merely turns the carrier signal on and off. However, the gating circuitry may provide additional capabilities. For example, the gating circuitry 440 may provide a conditional frequency hopping capability. With conditional frequency hopping, the gating circuitry 440 be configured to gate any one of a number of carrier signals, depending upon environmental conditions or other factors, so that the RF burst signals may be present at any one of a number of different frequencies. The gating circuitry 440 may also be configured to apply additional coding to the signal to avoid long sequences of consecutive symbols.

An advantage of digital transmitter 220 shown in FIG. 9 is that the antenna driver circuit 450 may introduce significant non-linearities in the transmitted signal without jeopardizing data integrity. In transmitters known in the art for most wireless communication systems, highly linear antenna drivers are needed to avoid data distortion or decreased performance. According to embodiments of the present invention, the antenna driver circuit 450 may be operated at higher power levels, even if those higher power levels introduce non-linearities in the transmitted signal.

The antenna driver circuit 450 preferably comprises only a power amplifier. In prior art systems, the power amplifier is typically one of the most power consuming and expensive active parts of the RF transmitter. Typical efficiencies in the vicinity of 30%-40% are common, especially in the higher frequency bands. The cost as well as low efficiency is mostly the result of difficult linearity constraints required by the conventional complex modulation and transmission approaches used in these prior art systems. In the digital transmitter depicted in FIG. 9, the amplifier's only constraint on linearity originates from possible frequency spectrum poisoning due to generation of spurious harmonics. When aiming at the higher frequency bands, FCC constraints are defined much more generously, and thereby relaxing the linearity constraints and allowing higher efficiency for much less unit cost. However, if the transmitting antenna 132 is designed to have a narrow enough bandwidth, the frequency filtering function will be performed by the antenna 132 and it's related passive parts. Hence, frequency spectrum poisoning will be minimized and thereby no linearity constraints on the amplifier.

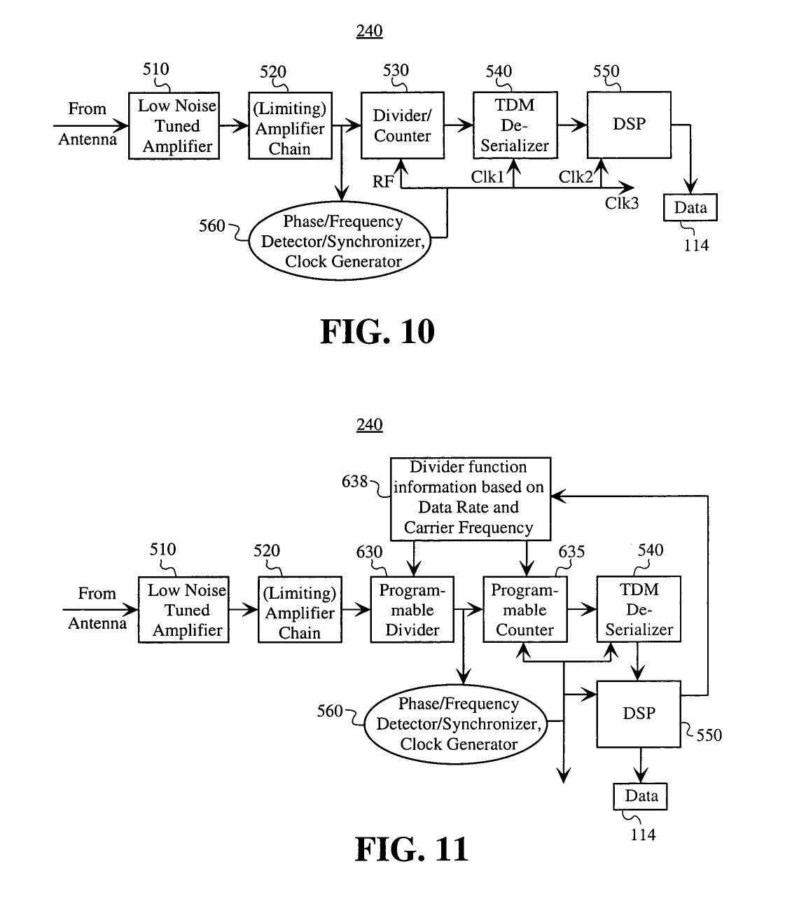

FIG. 10 shows a block diagram of the digital receiver 240 according to another embodiment of the present invention. In this embodiment of the digital receiver 240, the received signal from the receiving antenna 152 (not shown in FIG. 10) is coupled to a low noise amplifier (LNA) 510. The LNA 510 may be configured to tune to a specified frequency or range of frequencies. Further, to decrease the power requirements and/or complexity of the LNA 510, it may be significantly more non-linear than other LNAs typically used in wireless communication systems, without jeopardizing the integrity of the received data. For example, the LNA 510 may be operated well into its saturation for highest power efficiency. The LNA 510 may be followed by another limiting amplifier or chain of limiting amplifiers 520 that both amplify the received signal and limit the amplitude of the received signal to a specified “hard” limit.

The next stages of the digital receiver 240 shown in FIG. 10 provide for recovery of the digital data from the received signal. The amplified and limited signal from the chain of limiting amplifiers 520 is set to a synchronizing circuit 560, which generates a local oscillator signal, as well as any system clocks needed by additional circuitry in the receiver 240. Such synchronizing circuits are well-known in the art. For example, the synchronizing circuit 560 may simply comprise a phase locked loop (PLL).

One concern with embodiments of the present invention may be the ability for the digital receiver 240 to maintain synchronization with the RF burst signals, when the data symbols being transmitted cause no burst to be transmitted. It is known in the art to use block codes or other encoding techniques to limit the number of consecutive symbols. Hence, the synchronizing circuit 560 may be designed to withstand a maximum number of bit periods or carrier wave cycles without losing synchronization. Described in more detail below is an alternative approach in which the digital transmitter and receiver are configured to ensure that there the RF carrier wave is always present to ensure that the synchronization circuit stays locked.

The amplified and limited signal is also sent to a counter/divider 530. The counter/divider 530 counts, asynchronously, the number of consecutive periods present or absent in the amplified and limited signal to determine the logical one's and zero's in the received signal. Again, the length of present or absent periods gives a reference to the consecutive symbols, based on the data bit-rate. Counter/divider circuits are well-known in the art. However, the counter/divider hardware may need to be changed depending upon the frequency of the received signal and the number of periods corresponding to each bit of information in the received signal.

For example, the divider/counter 530 may simply comprise a divide by 2 circuit and a resetable counter. In this case, if each data bit corresponds to n-cycles of the carrier wave, it is preferred that n is an even number. The divide by 2 circuit would divide the RF frequency by 2. The divider in this case may very well be an asynchronous static divider. A counter coupled to the output of the divide by 2 circuit, then, simply counts the transitions output by the divide by 2 circuit, and as soon as the number of transitions correspond to n/2 periods of the carrier, the counter resets and thereby provides a “one” signal with the same length as it was transmitted.

Although the embodiment of the digital receiver 240 depicted in FIG. 10 shows a TDM deserializer 540 and DSP 550, other embodiments of the digital receiver 240 may not require these components if the serial output from the counter/divider 530 is suitable for further processing. The TDM deserializer 540 reformats the serial stream of data from the counter/divider 530 into one or more parallel streams of data. The DSP 550 in the digital receiver 240 shown in FIG. 9 basically performs any descrambling, decoding, or any other data processing required to undo any preprocessing performed on the data by the digital transmitter. Again, the DSP 550 may comprise typically microprocessor or application specific DSP circuits, depending on the required operating characteristics.

Another embodiment of a digital receiver 240 according to the present invention is shown in FIG. 11. This embodiment provides for programmable reconfiguration of the circuitry used to detect ones and zeros in the received signal. Like the digital receiver 240 depicted in FIG. 10, the digital receiver 240 shown in FIG. 11 preferably has a LNA 510 and a limiting amplifier chain 520 to both amplify and limit the received signal. This embodiment of the digital receiver 240 may also have a TDM deserializer 540 and DSP as discussed above. However, the capability of dividing the received signal and counting the periods may be provided with a programmable capability, as described below.

There may be a specific relationship between the frequency of the received signal's carrier frequency (F) and the equivalent number of carrier cycles corresponding to one bit of data (Nₚ). In the receiver 240 shown in FIG. 11, the information of the relation between F and Nₚ may be soft-coded in a programmable divider 630. The programmable divider 630 may simply be an asynchronous structure. As an asynchronous structure, the programmable divider 630 should not need require an external clock. In fact, the programmable divider 630 can provide a signal to the synchronizing circuit 560, such that the synchronizing circuit 560 does not have to be reconfigured based on the frequency of the received signal. The programmable divider may be programmed to provide an output consecutive symbols-signal with constant bandwidth to facilitate the clock generation of the synchronizer circuit 560. The synchronizer circuit 560 may still then provide the necessary system clock or clocks to the other components in the receiver 240.

The digital receiver 240 shown in FIG. 11 further comprises a programmable counter 635, which receives a divided signal from the programmable divider 630 and counts the equivalent number of periods to determine the presence of a one or zero and output the correct value. Both the programmable divider 630 and programmable counter 635 may receive the information on the relation between F and Nₚ from a programmable read-only memory (PROM) 638 or other storage device. Alternatively, the relationship may actually be extracted from the received data by the DSP 550 based on the eventual data transmission protocol structure. The DSP would calculate the appropriate values and provide these values to the programmable divider 630 and programmable counter 635.

As indicated above, the programmable asynchronous divider 630 depicted in FIG. 11 helps decrease the necessary operating speed of the following counter 635. The programmable asynchronous divider 630 also provides an additional advantage. As shown in FIG. 11, the divider 630 may be programmed to divide the carrier to a fixed frequency at all times. As a result, the PLL within the clock generator 560 may be designed to operate at a fixed frequency, regardless of the carrier frequency. The only constraint is, of course, that the carrier frequency must be higher than the PLL frequency. This relation allows real-time, online change of the carrier frequency, and also allows the number of carrier cycles within a data bit to become dynamic. If the number of carrier cycles is set to be an exponent of 2, the circuitry implementing the divider and counter circuits is simplified. However, this is not a requirement. If the number of carrier cycles is not set to an exponent of 2, the circuitry just becomes a bit more complex.

Configuring the digital receiver 240 depicted in FIG. 11 to operate with different relations between the carrier frequency F and the equivalent number of carrier cycles corresponding to one bit of data (Nₚ) may be accomplished in any number of different ways. The information regarding the relation between F and Np may either be extracted from the header of the arriving data packages (if the protocol allows transmission of control command, as most protocols do), or be entered through higher service levels. It may also be hard coded. In other words, a certain pattern is repeated based on predefined schedule or algorithm. Finally, it may be a combination of all the above. A number of bits prior to every package maybe added informing the receiver of the characteristics of the next package. This could easily be implemented in the DSP's framing routines.

The reconfigurability of the relation between F and Nₚ allows for communication systems according to the present invention to be reconfigured “on-the-fly.” That is, the relation can be changed during the transmission of data. One of the DSP's functions at the receiver end is to generate the proper “scaling” parameters to the programmable divider and counter. As a result, the data-rate, as well as the carrier frequency and the ratio of the data-width and number of RF-periods would create the necessary information for the DSP to reprogram the divider and counter. Note, however, that there will be a lapse of time due to the delay between the arrival of the information and readiness of the receiver for the new set-up. During this time, the system would be operating according to the previous set-up.

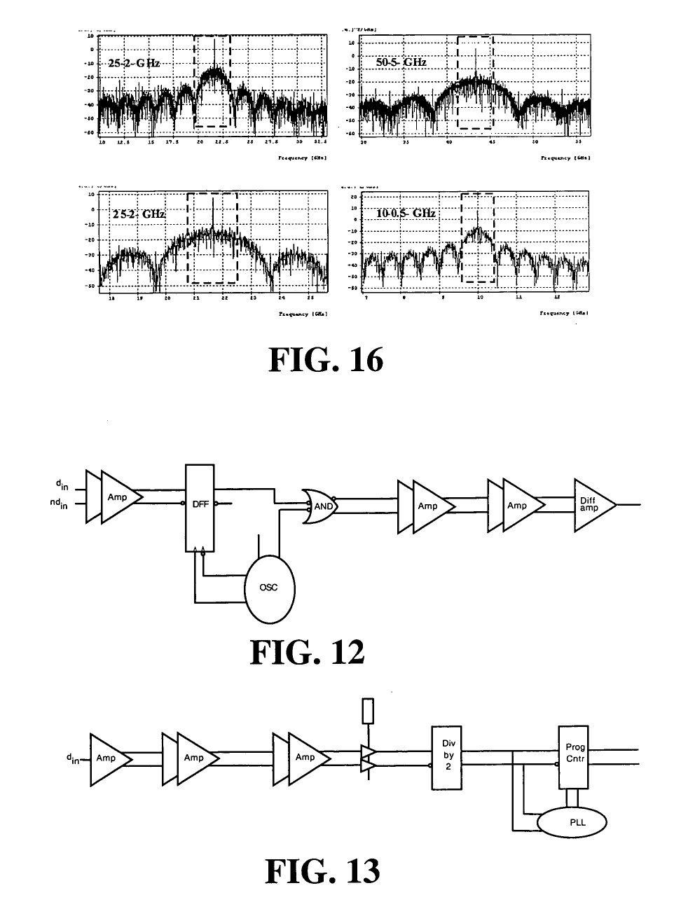

A preliminary “transistor” level simulation, using known high speed digital technology, has been performed to simulate the operation of a simplified version of the transmitter depicted in FIG. 9 and the receiver depicted in FIG. 10 and to establish a first order analysis. The transmitter and receiver test block diagrams are shown in FIG. 12 and FIG. 13, respectively.

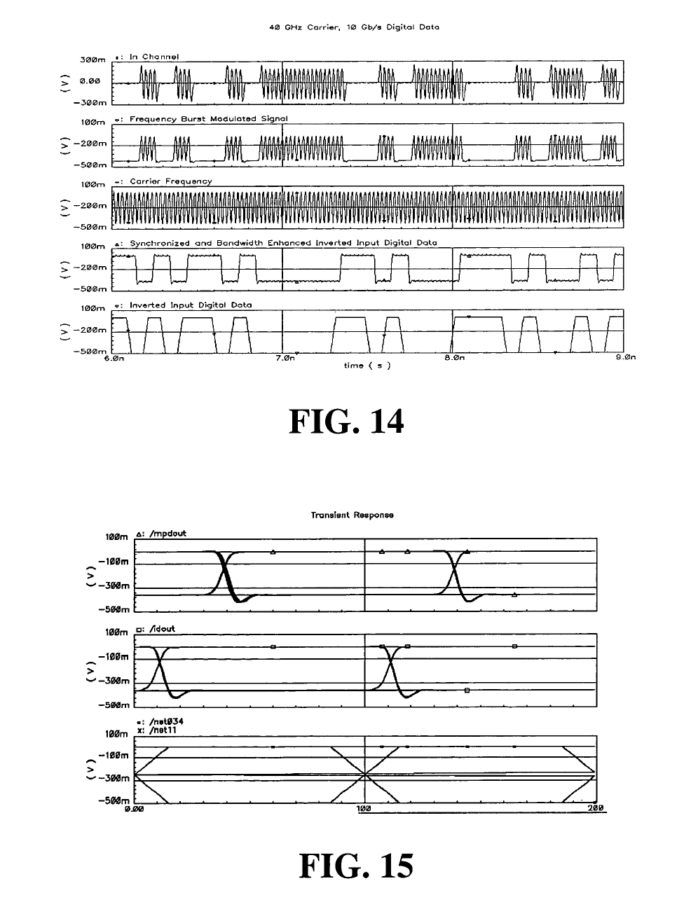

A very simple, “zero-th”-order lumped antenna model is used to emulate a band-pass transmit/receive antenna for direct and “multi-path” conditions. The transmission simulation results are presented in FIG. 14. The selected RF source is a 40 GHz oscillator to transmit a 10 Gbps digital data stream. The frequency selection implies that 4-RF cycles will represent one logical state of the data ((in this case logical high). The transmitter input and receiver output direct and multi-path resulting eye-diagrams at the receiver end, (prior to deserializer) are presented in FIG. 15. In FIG. 15, the eye-diagram waveforms at the transmitter input are shown at the lower portion of the figure, the receiver detected output from a “direct path” channel is shown at the middle portion and output from the combined “multi-path” channels is shown at the upper portion.

As briefly noted above, a concern with the reception of the RF burst waveform is that the digital receiver may lose sync with the transmitted signal if there is a long period during which no burst is being sent. As indicated above, the digital data may be coded to ensure that there are no long periods without RF bursts. Another approach for ensuring that the digital receiver maintains sync with the transmitted signal is depicted in FIG. 17.

FIG. 17 illustrates a communication system 900 in which a copy of the RF burst signal is transmitted by a vertically polarized antenna 932 and a second copy of the burst signal by the horizontally polarized antenna 933. A digital transmitter 920 comprises two RF gating circuits 225 which receive a carrier signal from the carrier generator 130. The digital data 112 controls the first RF gating circuit 225 as described above in relation to FIG. 5, so that the first RF gating circuit 225 produces an RF burst signal as described above. The inverse of the digital data is applied to a second RF gating circuit 225, so that the second RF gating circuit produces an RF burst when the first RF gating circuit 225 does not produce an RF burst. The output of the first RF gating circuit is applied to a vertically polarized transmit antenna 932 and the output of the second RF gating circuit is applied to a second transmit antenna 933. The use of different polarizations ensures that the signal from the two RF gating circuits 225 do not interfere with each other. The two differently polarized transmit antennas 932, 933 may be integrated into a single antenna, as long as sufficient isolation is maintained between the two differently polarized signals.

As shown in FIG. 17, the digital receiver comprises a digital RF demodulation circuit 945, a vertically polarized receive antenna 952 and a vertically polarized receive antenna 953. The vertically polarized receive antenna 952 would receive the vertically polarized RF burst (and reject the horizontally polarized RF burst) and the horizontally polarized receive antenna 953 would receive the horizontally polarized RF burst (and reject the vertically polarized RF burst). Similar to the digital transmitter 920, the digital receiver 940 may use a single antenna if proper isolation between the vertically polarized and horizontally polarized channels is maintained. The digital RF demodulation circuitry 945 contains circuits to individually detect and frequency count the vertically polarized and the horizontally polarized RF bursts. However, since the use of simultaneously separate polarizations ensures that the carrier wave will always be present in one polarization or the other, the synchronization circuits in the digital receiver 940 will have access to an ungated version of the carrier wave.

Returning to FIG. 5, embodiments of the present invention may use a switched beam transmitting antenna 132, which may be provided by a micro electro-mechanical system (MEMS) operated single radiating element or arrays of radiators using beam forming and switching options. The switched beam transmitting antenna 132 can then provide point-to-multi point wireless access network capabilities. Point-to-multi point (PtMP) connectivity can be achieved in a time division multiplexing access type of system, where the transmitting antenna looks into each user receiving antenna, each located at different geographical and angular positions, for a given time slot period. The transmitting antenna would then look to each user antenna for shared access in a periodic manner. Point-to-multi point connectivity may also be achieved by aligning the transmitting antenna with a user receiving antenna by demand and call setup to establish the communication. The demand and call set up may be included in the data communicated between a transmitter and a receiver. Once the communication need is over, the antenna beam can then be switched to a new user. The PtMP connectivity described above can be use to support a mesh network topology. Mesh topologies are used, for example, in non-line-of-sight (NLOS) wireless access systems.

Embodiments of the present invention described above generally use the transmission and reception of data by bursts of energy at radio frequencies. However, alternative embodiments of the present invention may use bursts of energy at optical frequencies using optical components or combinations of optical energy and radio frequency energy transmission and reception. These alternative embodiments are discussed in additional detail below. Please note that In this specification, the term “optical” is given the meaning typically used by those skilled in the art, that is, “optical” generally refers to that part of the electromagnetic spectrum which is generally known as the visible region together with those parts of the infrared and ultraviolet regions at each end of the visible region all of which are capable of being transmitted by dielectric optical waveguides such as optical fibers or by free space radiation through a vacuum or the atmosphere.

Similar to the “electrical’ RF wireless transmission systems described above and generally depicted in FIG. 5, data may also be transmitted by bursts of optical energy radiated through either free space and/or through fiber optic transmission systems. The optical burst signal generation, transmission and detection are performed in a similar manner to that described above for the RF systems, except that a carrier wave or carrier waves at optical frequencies are used.

In many of the embodiments of the present invention described above, the components directed to free space radiation of signals may be replaced with fiber optic components to provide for fiber optic-based communication systems according to other embodiments of the present invention. For example, in FIGS. 5, 7, 9, 10 and 11, the front-end transmitter and receiver components and the antenna components may be replaced with an opto-electronic transmitter in the transmitter (e.g, transmitter 220 in FIG. 5), an opto-electronic receiver in the receiver (e.g. receiver 240 in FIG. 5), and an optical fiber coupling the opto-electronic transmitter and the opto-electronic receiver.

Embodiments of the present invention using optical bursts may demonstrate advantages over conventional on/off intensity modulation techniques used in free space optical non-return-to-zero or return-to-zero optical systems known in the art including: reduced and lower optical channel sensitivity to the atmospheric turbulence and scintillations responsible for high level optical signal transmission degradation; increased receiver sensitivity, since detection is based on counting frequency cycles contained during each data bit, rather than the amplitude of the received bits alone; and lower transceiver design and hardware complexity due to decreased concerns about signal non-linearities and lower required terminal processing bandwidth. Therefore, embodiments of the present invention utilizing optical busts should demonstrate more robust optical links and enhanced system BER performance over free space optical communication systems know in the art.

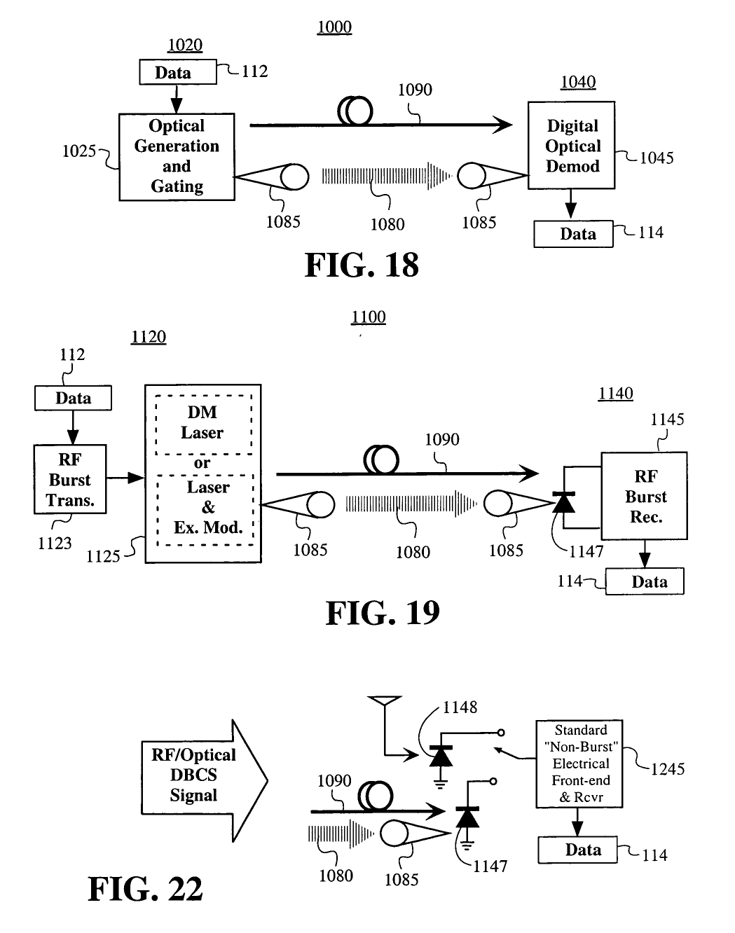

A generalized block diagram for an optical digital burst communication system 1000 according to an embodiment of the present invention is shown in FIG. 18. The optical digital burst communication system 1000 comprises an optical transmitter 1020 that has an optical generation and gating apparatus 1025, which gates one or more optical carrier signals based on the state of the digital input data 112. Preferably, at least one of the optical carrier signals is present when the state of the digital input data 112 is “1” and no carrier is present when the state is “0.” The optical generation and gating apparatus 1025 may provide the gated optical signal to an optical fiber (or other optical guided wave apparatus) 1090 or may radiate the gated optical signal as a free-space optical wave 1080 by using, for example, an optical telescope 1082.

As in the RF system described above and depicted in FIG. 5, the optical transmitter 1020 preferably transmits a specified number of cycles of the optical carrier for each digital data bit. Alternatively, the optical transmitter 1020 may transmit a burst optical signal that, when detected, demodulates to an electrical signal with a specified number of cycles of a radio frequency signal for each digital data bit. This is described in additional detail below.

The communication system 1000 further comprises an optical receiver 1040 that has a digital optical demodulator 1045. The digital optical demodulator 1045 detects the number of optical carrier cycles and/or corresponding radio frequency cycles in the gated optical signal to determine whether a digital data “0” or “1” has been sent. As shown in FIG. 18, the optical receiver 1040 may receive the gated optical signal by optical fiber (or other optical guided wave apparatus) 1090 or as a free space optical wave 1080 by using, for example, an optical telescope 1082.

An electro-optic optical digital burst communication system 1100 according to an embodiment of the present invention is shown in FIG. 19. The electro-optic optical digital burst communication system 1100 comprises an optical transmitter 1120 and an optical receiver 1140. The optical transmitter 1120 comprises a RF burst transmitter 1123 that is used to drive an optical generation and gating apparatus 1120. The optical generation and gating apparatus 1120 may comprise a laser diode that is directly modulated by the output of the RF burst transmitter 1123 or a laser diode that has its output modulated by an external optical modulator driven by the RF burst transmitter 1123. The RF burst transmitter 1123 preferably comprises one of the RF burst transmitter embodiments described above, such as the transmitter 220 shown in FIG. 5, the transmitter 520 shown in FIG. 8, or the transmitter 220 shown in FIG. 9.

The optical signal that is gated by the optical transmitter 1120 may again be sent to the optical receiver 1140 as a free-space optical wave 1080 or by optical fiber 1090. The optical receiver 1140 preferably comprises a photo-detector 1147 that converts the gated optical signal into an RF or electrical burst signal. The RF burst signal is then provided to an RF burst receiver 1145, which preferably comprises one of the RF burst receiver embodiments described above, such as the receiver 240 in FIG. 5, the receiver 240 shown in FIG. 10, or the receiver 240 shown in FIG. 11. The RF burst receiver 1145 then provides the detected digital data 114.

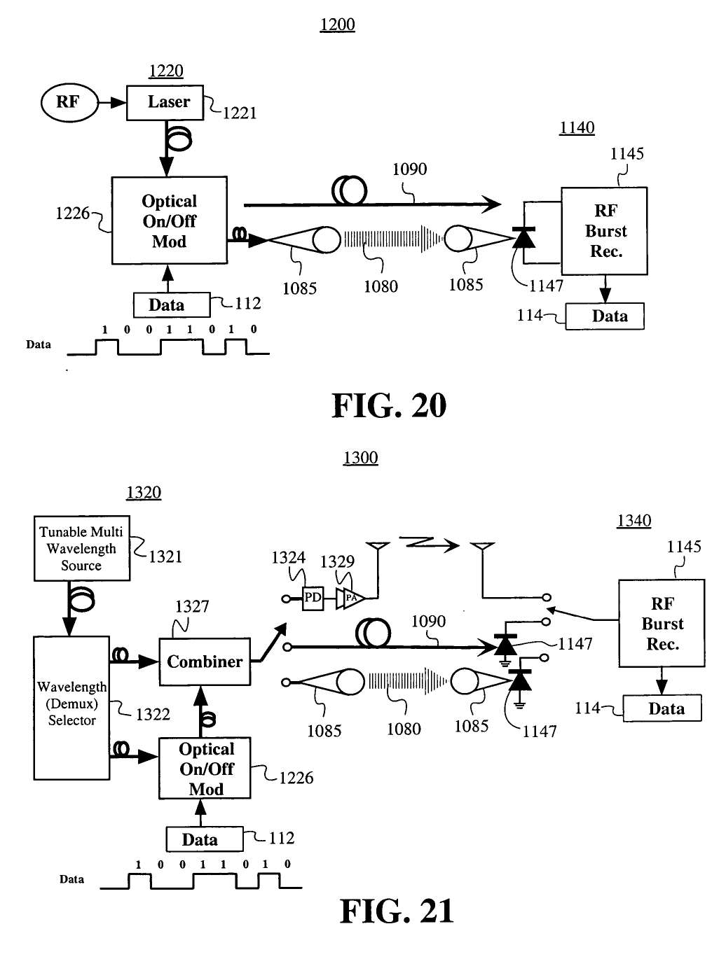

Another optical digital burst communication system 1200 according to an embodiment of the present invention having an optical transmitter 1220 and the optical receiver 1140 is shown in FIG. 20. This embodiment does not require the use of the RF burst transceiver 1123 hardware as described above in the embodiment depicted in FIG. 19. The optical transmitter 1220 comprises a laser diode 1221 or other laser apparatus that is directly modulated with an external modulator 1226 or voltage controlled oscillator to allow frequency tuning. The laser diode 1221 generates a continuous optical carrier that has an amplitude that is modulated by the external modulator 1226. Alternatively, an unmodulated continuous wave laser diode signal may be used in conjunction with an external intensity modulator (not shown) to generate a modulated optical carrier.

The modulated optical carrier wave is then sent to an optical modulator 1226 that gates the optical carrier wave on and off according to the state of the digital input data 112. Preferably, a non-return-to-zero data format is used in the optical modulator 1226 so that a lower bandwidth may be required for the optical modulator 1226. However, return-to-zero modulation may also be used. The gated optical signal may then be sent to the optical receiver 1140 as a free-space optical wave 1080 or by optical fiber 1090. The gated optical signal is then received by an optical receiver 1140 that preferably comprises the optical receiver as described above for the embodiment depicted in FIG. 19.

A digital communication system 1300 according to another embodiment of the present invention is shown in FIG. 21. In this embodiment, radiation of the digital communication system is in either or both the radio frequency spectrum and the optical spectrum. Further, the selected frequency band or bands in the spectrum can be switched (either in steps or tunable) for band selection and/or frequency hopping/coding purposes. This band-tunable digital burst communication system 1300 comprises an optical/RF transmitter 1320 and an optical/RF receiver 1340 as shown in FIG. 21.

The optical/RF transmitter 1320 comprises an optical source 1321 that generates two or more optical wavelength division multiplexed signals. The optical source 1321 may comprise, for example, a mode locked laser, an electro-optic oscillator, a multi-mode single laser diode, phase-locked multiple DFB lasers, or other such devices known in the art. The optical source 1321 generates the two or more optical signals with wavelength separations Δλ that are preferably at radio frequencies. The radio frequency F_{c} can be calculated from the wavelength separation Δλ by the following equation: F_{c}=c/(Δλ=λ₁−λ₂), where c is the speed of light.

The multiple wavelength optical output from the optical source 1321 is coupled to a demultiplexer 1322, which separates the optical signals in the multiple wavelength optical output by wavelength. The demultiplexer 1322 may be implemented by such devices well known in the art. The optical signal at a first wavelength is coupled to an optical on/off modulator 1226, which modulates the optical signal at the first wavelength with the input digital data 112. The optical signal at the first wavelength is then combined with at least one other unmodulated optical signal in a combiner 1324. The optical output of the combiner may be selectably sent to an optical fiber 1090, radiated as a free-space optical signal 1080, and/or coupled to a photo-detector 1326 for conversion in an electrical signal. The electrical signal will have a frequency F_{c} equal to the frequency separation of the unmodulated and modulated optical signals. One or more power amplifiers 1327 may be used to boost the power of the electrical signal before radiation by an antenna 1329.

The optical/RF receiver 1340 preferably comprises one of the RF burst receiver embodiments described above, such as the receiver 240 in FIG. 5, the receiver 240 shown in FIG. 10, or the receiver 240 shown in FIG. 11. The RF burst receiver 1145 then provides the detected digital data 114. For optical signals sent from the optical/RF transmitter 1320, photo-detectors 1147 are used to convert the optical signals into electrical signals for the RF burst receiver 1145. The radiated electrical signal may be directly coupled into the RF burst receiver 1145 without any conversion. As shown in FIG. 21, the input into the RF burst receiver 1145 may be selected.

Frequency band switching in the embodiment depicted in FIG. 21 may be achieved by selection of unmodulated optical signals at different wavelengths by the demultiplexer 1322. These unmodulated optical signals should have different wavelength offsets from the modulated optical signal. Frequency band switching may also be achieved by tuning the drive frequency of a mode-locked laser used in the optical source 1321, which will then alter the pulse repetition frequency and mode separation of the optical output from the mode-locked laser resulting in beat frequency tuning.

As discussed above, the optical receiver 1140 depicted in FIGS. 19 and 20 or the optical/RF receiver 1340 depicted in FIG. 21 preferably comprises one of the RF burst receiver embodiments described earlier, such as the receiver 240 in FIG. 5, the receiver 240 shown in FIG. 10, or the receiver 240 shown in FIG. 11. However, other embodiments may use envelope detection (either optical or electrical) to detect and process digital burst communication system signals with a conventional receiver. FIG. 22 shows a block diagram where optical signals are directed to a photo-detector 1147 for conversion to an electrical signal and electrical signals are directed to a RF/microwave diode detector 1148 for downconversion. The outputs from the photodetector 1147 and the diode 1148 are then directed to a conventional high speed receiver 1245, such as a receiver typically used in fiber optic transmission systems.

The RF/microwave diode detector 1148 is used to detect the incoming burst envelope in the RF/microwave/millimeter wave spectrum and convert the “burst” signal format into a pure baseband digital on/off bit format. The frequency bandwidth of the diode detector 1148 preferably is much smaller than the carrier frequency F_{c} and just below the modulation bandwidth Fₘ. In a conventional receiver such as the receiver 1245 to be used in the embodiment depicted in FIG. 22, the modulation bandwidth is typically 0.6 times the data modulation bandwidth.

For an optical signal transmitted either by fiber 1090 or as a free-space optical signal 1080, the photo-detector 1147 serves as an optical envelope detector to convert the incoming optical burst signal into a pure baseband digital on/off bit format. The frequency bandwidth of the photodetector 1147 is preferably much small than the carrier frequency F_{c} and just below the modulation bandwidth Fₘ. Again, in a conventional receiver, the modulation bandwidth is typically 0.6 times the data modulation bandwidth.

In high-speed heterogeneous integrated networks (where both optical and RF links are used to carry data), the data signals typically have to be coupled from RF links into optical links and vice versa, by repeat or regeneration stages. These stages typically increase the costs of the networks and may also impact the speed or reliability of the networks. Heterogeneous integrated networks using embodiments of the digital burst communication systems discussed above provide architectures and interconnect techniques that can provide relatively seamless interfaces between Gigabit digital burst communication system RF wireless links and baseband digital RF, and/or free-space optical links, without any data format conversions. The RF digital burst communication system signal generation/detection technology and interface architecture described above should allow for the standard on/off baseband data format to be used for the data transfer/repeat/regenerate function without the need for any data format transformation.

For example, embodiments of the present invention provide for converting an RF burst signal from a digital burst communication system to a standard fiber or free space optical wireless data format by using a DBCS receiver as described above (or a microwave diode envelope detector). The output of the DBCS receiver is then applied to a conventional/standard optical transmitter for transmission of an optical signal using a standard optical format.

In another embodiment according to the present invention, a RF DBCS can be coupled to a optical (either fiber or free-space optical wireless) DBCS by receiving the RF burst signal from the RF DBCS, amplifying the signal and using it to drive a laser diode for the generation of a DBCS optical signal. Alternatively, a band limited laser diode (having a laser bandwidth much less than the RF carrier frequency F_{c} but sufficient for the data modulation frequency Fₘ) can be driven with the received RF burst signal. This will convert the electrical DBCS data format into a conventional optical on/off baseband signal for the repeat/regeneration function and allow for data flow into standard optical transmit/receiver terminal equipment.

From the foregoing description, it will be apparent that embodiments of the present invention has a number of advantages, some of which have been described herein, and others of which are inherent in the embodiments of the invention described or claimed herein. Also, it will be understood that modifications can be made to the embodiments described herein without departing from the teachings of subject matter described herein. As such, the invention is not to be limited to the described embodiments except as required by the appended claims.

What is claimed is:

1. A communication system for transmitting and receiving digital data comprising:
a transmitter transmitting one or more digitally gated carrier waves gated by said digital data and
a receiver detecting at least one digitally gated carrier wave of the one or more digitally gated carrier waves,
wherein said receiver determines a state of said digital data by counting cycles of the at least one digitally gated carrier wave of the one or more digitally gated carrier waves.

2. The communication system according to claim 1, wherein at least one digitally gated carrier wave has a frequency in the less than microwave, microwave, millimeter wave, or optical spectrum and is radiated in free space from said transmitter to said receiver.

3. The communication system according to claim 1, wherein at least one digitally gated carrier wave has a frequency in the less than microwave, microwave, millimeter wave, or optical spectrum and is directed from said transmitter to said receiver by one or more guided wave devices.

4. The communication system according to claim 1, where said transmitter comprises:
a carrier wave generator; and
a digital gating device coupled to said carrier wave generator and controlled by said digital data, said digital gating device gating a carrier wave from said carrier wave generator on and off according to a state of the digital data.

5. The communication system according to claim 4, wherein said transmitter further comprises a power amplifier disposed at said output of said digital gating device and coupled to at least one transmit antenna.

6. The communication system according to claim 5, wherein said power amplifier is operated in a non-linear region of operation.

7. The communication system according to claim 4, where said carrier wave generator comprises:
a multi-tone optical generator and
a photo detector receiving a multi-tone optical signal from said multi-tone optical generator,
wherein at least two tones from said multi-tone optical generator are separated in frequency by a desired frequency for said carrier wave.

8. The communication system according to claim 7, wherein said multi-tone optical generator is located remotely from said digital gating device, said multi-tone optical generator being controlled by a network operations center.

9. The communication system according to claim 8, wherein said network operations center controls said tones of said multi-tone optical generator.

10. The communication system according to claim 9, wherein said network operations center controls said tones of said multi-tone optical generator according to a data rate of said digital data.

11. The communication system according to claim 1, where said transmitter comprises:
a multi-tone optical generator generating at least two optical tones separated in frequency by a desired carrier frequency;
an optical modulator controlled by said digital data, said optical modulator gating one of said two optical tones on and off according to a state of said digital data; and
a photodetector receiving said at least two optical tones.

12. The communication system according to claim 1, wherein the presence of a specified number of cycles in said at least one digitally gated carrier wave indicates a first state of said digital data and the absence of a specified number of cycles in said at least one digitally gated carrier wave indicates a second state of said digital data and said receiver comprises digital counting circuitry counting the number of cycles present in and counting the number of cycles absent from said at least one digitally gated carrier wave.

13. The communication system according to claim 12, wherein said receiver additionally comprises:
a receive antenna;
a low noise amplifier coupled to said receive antenna;
a limiter circuit coupled to an output of said low noise amplifier and providing an output to said digital counting circuitry; and
a digital signal processor receiving an output from said digital counting circuitry.

14. The communication system according to claim 1, wherein said transmitter transmits said gated carrier wave at a first polarization for a first state of said digital data and transmits said gated carrier wave at a second polarization for a second state of said digital data.

15. The communication system according to claim 1, wherein said transmitter comprises:
a carrier wave generator generating an electrical carrier wave;
a digital gating device coupled to said carrier wave generator and controlled by said digital data, said digital gating device gating the electrical carrier wave on and off according to a state of the digital data; and
an optical modulator generating said at least one digitally gated carrier wave at an optical frequency, said optical modulator being controlled by said electrical carrier wave.

16. The communication system according to claim 1, wherein said transmitter comprises:
an optical carrier wave generator generating one or more optical carrier waves; and
an optical modulator receiving at least one of the one or more optical carrier waves and gating the at least one optical carrier wave on and off according to a state of the digital data.

17. The communication system according to claim 1, wherein said at least one digitally gated carrier wave has a frequency at an optical frequency and said receiver comprises:
a photo-detector receiving said at least one digitally gated carrier wave;
digital counting circuitry counting the number of cycles present in and counting the number of cycles absent from said at least one digitally gated carrier wave;
a limiter circuit receiving an electrical output from said photo-detector and providing an output to said digital counting circuitry; and
a digital signal processor receiving an output from said digital counting circuitry.

18. The communication system according to claim 1, wherein said transmitter selectably generates said at least one digitally gated carrier wave at selectable optical and/or selectable radio frequencies.

19. The communication system according to claim 18, wherein said transmitter comprises:
an optical source generating two or more optical wavelength division multiplexed carriers;
a demultiplexer receiving said two or more optical carriers and producing a first optical output at a first optical frequency and at least one other optical output at another optical frequency;
an optical modulator receiving the first optical output and controlled by said digital data to produce a gated optical carrier wave; and
a combiner receiving said gated optical carrier wave and said at least one other optical output, wherein an output from said combiner is selectably directed to an optical fiber, a photo-diode, or is radiated in free space.

20. The communication system according to claim 1, wherein said at least one digitally gated carrier wave is generated at selectable optical and/or selectable radio frequencies and said receiver comprises:
at least one antenna for receiving said at least one digitally gated carrier wave at radio frequencies, and
one or more photo-diodes for receiving said at least one digitally gated carrier wave at optical frequencies.

21. The communication system according to claim 20, wherein said receiver additional comprises a diode detector coupled to said at least one antenna, wherein said diode detector produces a baseband digital on/off bit format signal.

22. The communication system according to claim 18, wherein selection of said optical and/or radio frequencies is for coding purposes.

23. A method for transmitting and receiving digital data comprising:
gating one or more carrier waves with said digital data to produce one or more gated carrier waves;
detecting at least one of said one or more gated carrier waves; and
counting cycles of said at least one gated carrier wave to determine a state of said digital data.

24. The method according to claim 23, wherein said at least one gated carrier wave has a frequency in the less than microwave, microwave, millimeter wave, or optical spectrum and said at least one gated carrier wave is radiated in free space.

25. The method according to claim 23, wherein said at least one gated carrier wave has a frequency in the less than microwave, microwave, millimeter wave, or optical spectrum and said method additionally comprises directing said into a guided wave device after the gating step and prior to the detecting step.

26. The method according to claim 23, wherein said gating one or more carrier waves with said digital data comprises:
generating said one or more carrier waves; and
digitally gating at least one of said one or more carrier waves on and off according to a state of the digital data to produce said one or more gated carrier waves.

27. The method according to claim 26, wherein said method further comprises:
amplifying said one or more gated carrier waves; and
coupling said one or more gated carrier waves to at least one transmitting antenna.

28. The method according to claim 27, wherein amplifying said one or more gated carrier waves comprises coupling said one or more gated carrier waves to a power amplifier and operating said power amplifier in a non-linear region of operation.

29. The method according to claim 26, wherein generating said one or more carrier waves comprises:
generating at least one multi-tone optical signal, wherein at least two tones of said at least one multi-tone optical signal are separated in frequency by a desired frequency for said at least one carrier wave; and
photo-detecting said at least one multi-tone optical signal to generate an electrical signal.

30. The method according to claim 29 wherein said at least one multi-tone optical signal is generated at and controlled by a network operations center.

31. The method according to claim 30, wherein said network operations center selects the at least tow tones of the multi-tone optical signal.

32. The method according to claim 31, wherein said at least two tones are selected according to a data rate of said digital data.

33. The method according to claim 23, wherein gating one or more carrier waves comprises:
generating at least one multi-tone optical signal, wherein at least two tones of said at least one multi-tone optical signal are separated in frequency by a desired frequency for said at least one carrier wave;
gating at least one of said two optical tones one and off according to a state of said digital data; and
photo-detecting said at least two tones to generate an electrical signal.

34. The method according to claim 23, wherein the presence of a specified number of cycles in said at least one gated carrier wave indicates a first state of said digital data and the absence of a specified number of cycles in said at least one gated carrier wave indicates a second state of said digital data.

35. The method according to claim 34, wherein detecting at least one of said one or more gated carrier waves comprises:
receiving said at least one gated carrier wave at one or more receive antennas;
amplifying said at least one gated carrier wave received at said receive antenna to produce an amplified gated carrier wave; and
limiting an amplitude of said amplified gated carrier wave.

36. The method according to claim 23 further comprising:
transmitting at least one gated carrier wave at a first polarization for a first state of said digital data; and
transmitting said at least one gated carrier wave at a second polarization for a second state of said digital data.

37. The method according to claim 23, wherein gating one or more carrier waves comprises:
generating one or more electrical carrier waves;
digitally gating at least one of said one or more electrical carrier waves on and off according to a state of the digital data to produce one or more gated electrical carrier waves; and
modulating at least one optical carrier wave with at least one of said one or more gated electrical carrier waves to produce said one or more gated carrier waves.

38. The method according to claim 23, wherein gating one or more carrier waves comprises:
generating one or more optical carrier waves;
digitally gating at least one of said one or more optical carrier waves on and off according to a state of the digital data to produce said one or more gated carrier waves.

39. The method according to claim 23 wherein at least one gated carrier wave has a frequency in the optical spectrum and detecting at least one of said one or more gated carrier waves comprises:
photo-detecting said at least one of said one or more gated carrier waves to produce a gated electrical signal; and
limiting an amplitude of said amplified gated electrical signal.

40. The method according to claim 23, further comprising:
selecting at least one optical and/or radio frequency for said one or more gated carrier waves.

41. The method according to claim 40, wherein gating one or more carrier waves comprises:
generating two or more optical wavelength division multiplexed carriers;
demultiplexing said two or more optical wavelength division multiplexed carriers to produce a first optical output at a first optical frequency and at least one other optical output at another optical frequency;
modulating said first optical output with said digital data to produce a gated optical carrier wave; and
selectably coupling said gated optical carrier wave to a guided wave device or to an optical radiator to radiate said at least one of said one or more gated carrier waves; or
heterodyning said gated optical carrier wave with said at least one other optical output to produce a gated electrical carrier wave; and
radiating said gated electrical carrier wave as said at least one of said one or more gated carrier waves.

42. The method according to claim 40, wherein detecting at least one of said one or more gated carrier waves comprises:
receiving said at least one gated carrier wave at one or more antennas; or
receiving said at least one gated carrier wave at one or more photo-diodes.

43. The method according to claim 42, wherein the method additionally comprises coupling said at least one gated carrier wave received at said one or more antennas to a diode detector to produce a baseband digital on/off bit format signal.

44. The method according to claim 40, wherein the digital data is coded by the selection of said at least one optical and/or radio frequency.

45. An apparatus for transmitting and receiving digital data comprising:
means for transmitting one or more gated carrier waves gated by said digital data and
means for receiving at least one gated carrier wave of the one or more gated carrier waves,
wherein said means for receiving determines a state of said digital data by counting cycles of the at least one gated carrier wave of the one or more gated carrier waves.

46. The apparatus according to claim 45, wherein at least one gated carrier wave has a frequency in the less than microwave, microwave, millimeter wave, or optical spectrum and is radiated in free space from said means for transmitting to said means for receiving.

47. The apparatus according to claim 45, wherein at least one gated carrier wave has a frequency in the less than microwave, microwave, millimeter wave, or optical spectrum and is directed from said means for transmitting to said means for receiving by one or more guided wave devices.

48. The apparatus according to claim 45, where said means for transmitting comprises:
means for generating a carrier wave; and
means for gating, said means for gating coupled to said means for generating a carrier wave and controlled by said digital data, said means for gating gating a carrier wave from said means for generating a carrier wave on and off according to a state of the digital data.

49. The apparatus according to claim 48, wherein said means for transmitting further comprises a means for amplifying disposed at said output of said mean for gating and coupled to a means for radiating.

50. The apparatus according to claim 49, wherein said means for amplifying is operated in a non-linear region of operation.

51. The apparatus according to claim 48, where said means for generating a carrier wave comprises:
means for generating a multi-tone optical signal and
means for photo-detecting an optical signal, said means for photo-detecting receiving a multi-tone optical signal from said means for generating a multi-tone optical signal,
wherein at least two tones from said means for generating a multi-tone optical signal are separated in frequency by a desired frequency for said carrier wave.

52. The apparatus according to claim 51 wherein said means for generating a multi-tone optical signal is located remotely from said means for gating, said means for generating a multi-tone optical signal being controlled by a network operations center.

53. The apparatus according to claim 52, wherein said network operations center controls said tones from said means for generating a multi-tone optical signal.

54. The apparatus according to claim 53, wherein said network operations center controls said tones from said means for generating a multi-tone optical signal according to a data rate of said digital data.

55. The apparatus according to claim 45, where said means for transmitting comprises:
means for generating a multi-tone optical signal generating at least two optical tones separated in frequency by a desired carrier frequency;
means for optically modulating, said means for optically modulating controlled by said digital data and gating one of said two optical tones on and off according to a state of said digital data; and
means for photodetecting, said means for photodetecting receiving said at least two optical tones.

56. The apparatus according to claim 45, wherein the presence of a specified number of cycles in said at least one gated carrier wave indicates a first state of said digital data and the absence of a specified number of cycles in said at least one gated carrier wave indicates a second state of said digital data and said means for receiving comprises means for counting, said means for counting counting the number of cycles present in and counting the number of cycles absent from said at least one gated carrier wave.

57. The apparatus according to claim 56, wherein said means for receiving additionally comprises:
means for receiving a radiated signal;
means for amplifying, said means for amplifying coupled to said means for receiving a radiated signal;
means for limiting, said means for limiting coupled to an output of said means for amplifying and providing an output to said means for counting; and
means for processing, said means for processing receiving an output from said means for counting.

58. The apparatus according to claim 45, wherein said means for transmitting transmits said gated carrier wave at a first polarization for a first state of said digital data and transmits said gated carrier wave at a second polarization for a second state of said digital data.

59. The apparatus according to claim 45, wherein said means for transmitting comprises:
means for generating an electrical carrier wave;
means for gating, said means for gating coupled to said means for generating an electrical carrier wave and controlled by said digital data, said means for gating gating an electrical carrier wave on and off according to a state of the digital data; and
means for optical modulation, said means for optical modulation controlled by said electrical carrier wave and generating said at least one digitally gated carrier wave at an optical frequency.

60. The apparatus according to claim 45, wherein said means for transmitting comprises:
means for generating one or more optical carrier waves; and
means for optical modulation, said means for optical modulation receiving at least one optical carrier wave from the means for generating one or more optical carrier waves and gating the at least one optical carrier wave on and off according to a state of the digital data.

61. The apparatus according to claim 45, wherein said at least one gated carrier wave has a frequency at an optical frequency and said means for receiving comprises:
means for photo-detecting, said means for photo-detecting receiving said at least one gated carrier wave;
means for counting, said means for counting counting the number of cycles present in and counting the number of cycles absent from said at least one gated carrier wave;
means for limiting, said means for limiting receiving an electrical output from said means for photo-detecting and providing an output to said means for counting; and
means for processing, said means for processing receiving an output from said means for counting.

62. The apparatus according to claim 45, wherein said means for transmitting selectably generates said at least one gated carrier wave at selectable optical and/or selectable radio frequencies.

63. The apparatus according to claim 62, wherein said means for transmitting comprises:
means for generating two or more optical wavelength division multiplexed carriers;
means for demultiplexing, said means for demultiplexing receiving two or more optical carriers from said means for generating and producing a first optical output at a first optical frequency and at least one other optical output at another optical frequency;
means for optical modulation, said means for optical modulation receiving the first optical output and controlled by said digital data to produce a gated optical carrier wave; and
means for combining, said means for combining receiving said gated optical carrier wave and said at least one other optical output, wherein an output from said means for combining is selectably directed to an optical fiber, a photo-diode, or is radiated in free space.

64. The apparatus according to claim 45, wherein said at least one gated carrier wave is generated at selectable optical and/or selectable radio frequencies and said means for receiving comprises:
means for receiving a radiated electrical signal, said means for receiving a radiated electrical signal said at least one gated carrier wave at radio frequencies, and
means for photo-detection, said means for photo-detection receiving said at least one gated carrier wave at optical frequencies.

65. The apparatus according to claim 64, wherein said means for receiving additional comprises a diode detector coupled to said means for receiving a radiated electrical signal, wherein said diode detector produces a baseband digital on/off bit format signal.

66. The apparatus according to claim 45, wherein means for transmitting comprises means for selecting one or more optical and/or selectable radio frequencies for said at least one gated carrier wave based on a desired coding.

67. A digital transmitter for transmitting digital data comprising:
a carrier generator providing one or more carrier signals at selected frequencies;
a serializer coupled to said digital data and producing a serial stream of digital bits;
a data edge synchronizer coupled to said serial stream of digital bits and receiving at least one carrier signal of said one or more carrier signals, said data edge synchronizer producing a synchronized stream of digital bits, wherein at least one edge of each digital bit in said synchronized stream of digital bits is synchronized to a specified part of each cycle within said at least one carrier signal; and
a gating circuit gating at least one carrier signal of said one or more carrier signals according to each digital bit in said synchronized stream of digital bits.

68. The digital transmitter according to claim 67, wherein said data edge synchronizer comprises:
one or more wide-band limiting amplifiers coupled to said serial stream of digital bits; and
a flip-flop coupled to an output of said one or more wide-band limiting amplifiers.

69. The digital transmitter of claim 68, wherein said flip-flop comprises a latch or D flip-flop.

70. The digital transmitter of claim 67, wherein said gating circuit gates said at least one carrier signal on and off.

71. The digital transmitter of claim 67 wherein said gating circuit selects one carrier signal of said one or more carrier signals and gates the selected carrier signal.

72. The digital transmitter of claim 67, wherein said gating circuit gates said at least one carrier signal according to each digital bit in said synchronized stream of digital bits and according to a specified code sequence.

73. A digital receiver for receiving a carrier signal gated by digital data:
an amplifier receiving said carrier signal and providing an amplified signal;
a limiting circuit coupled to said amplifier, said limiting circuit receiving said amplified signal and providing a limited signal; and
a divider/counter coupled to said limiting circuit, said divider/counter counting a number of consecutive periods present or absent in said limited signal to provide a digital output.

74. The digital receiver of claim 73, said digital receiver further comprising a synchronizing circuit, said synchronizing circuit generating a local oscillator signal based on a frequency of said carrier signal.

75. The digital receiver of claim 74, wherein said divider/counter comprises:
a divider coupled to said limiting circuit, said divider providing a divider signal to said synchronizer circuit, wherein said local oscillator signal is based on said divider signal; and
a counter receiving said divider signal and counting a number of consecutive periods present or absent in said divider signal to provide a digital output.

76. The digital receiver of claim 75, wherein a relationship between the frequency of said carrier and a number of carrier cycles corresponding to a data bit is specified and said divider and said counter are configured according to the specified relationship.

77. The digital receiver of claim 76, wherein said specified relationship is changeable.

78. A method for transmitting digital data comprising:
generating at least one carrier signal;
converting said digital data to a stream of serial digital bits;
synchronizing said stream of serial digital bits to said at least one carrier signal to generate a synchronized stream of digital bits such that at least one edge of each digital bit in said synchronized stream of digital bits is synchronized to a selected part of each cycle within said at least one carrier signal; and
gating said at least one carrier signal according to each digital bit in said synchronized stream of digital bits.

79. The method according to claim 78, wherein synchronizing said stream of serial digital bits comprises:
amplifying said stream of serial digital bits to generate an amplified stream of serial digital bits;
limiting said amplified stream of serial digital bits to generate a limited stream of serial digital bits;
coupling said limited stream of serial digital bits to a latch or D-type flip-flop; and
clocking said latch or D-type flip-flop with said at least one carrier signal to generate said synchronized stream of digital bits.

80. The method according to claim 78, wherein at least one carrier signal comprises a plurality of carrier signals and said gating comprises gating a selected one or more of said plurality of carrier signals.

81. The method according to claim 78, wherein said gating additionally comprises gating said at least one carrier signal according to a selected code sequence.

82. A method for receiving a carrier signal gated by digital data comprising:
generating a synchronized clock signal based on said carrier signal;
comparing said carrier signal to said synchronized clock signal;
counting a number of consecutive periods present in or absent from said carrier signal based on the comparison of said carrier signal to said synchronized clock signal;
determining a state of a digital bit based on the count of consecutive periods; and
providing a serial stream based on the determined state of each digital bit.

83. The method according to claim 82, wherein the count of consecutive periods for a state of a digital bit is related to a frequency of the carrier signal.

84. The method according to claim 82, wherein the method further comprises converting said serial stream to a parallel output.

85. The method according to claim 82, wherein said digital data has a header that defines the number of consecutive periods used to determine a state of a digital bit.
